(19) United States
(12) Patent Application Publication
(10) Pub. No.: US 2020/0202091 A1
(43) Pub. Date: Jun. 25, 2020

(54) SYSTEM AND METHOD TO ENHANCE IMAGE INPUT FOR OBJECT RECOGNITION SYSTEM

(71) Applicant: Zebra Technologies Corporation, Lincolnshire, IL (US)

(72) Inventors: Sajan Wilfred, Kollam (IN); Robert James Pang, Williston Park, NY (US); Edward Barkan, Miller Place, NY (US); Christopher J. Fjellstad, Smithtown, NY (US)

(21) Appl. No.: 16/228,317

(22) Filed: Dec. 20, 2018

(51) Int. Cl. G06K 7/14; G06N 3/02; G06K 7/12

(52) U.S. Cl. CPC G06K 7/1413; G06K 7/12; G06N 3/02

(57) ABSTRACT

A multi-plane scanner device, such as a bi-optic barcode scanner, includes a color imager for generating color image data on a scanned object and one or more sensors for generating sensed data on the object. Particularly, the sensors include a hyperspectral sensor configured to capture non-visible sensed data on the scanned object. The color image and sensed data are provided to a classification server implementing a neural network framework that generates a classification model for identifying objects based on the both the image data and the sensed data.

### BACKGROUND OF THE INVENTION

With increasing computing power, neural networks are now being used in image processing and recognition systems to identify objects of interest in an image. Neural networks provide predictive models for identification. Yet, the success of such predictions relies heavily on the quality of the input images used to train these neural networks. For a neural network to be effective, the input images should be of a sufficiently high quality at the time of classification (also referred to as time of “recognition”). Although high quality imager capture devices exist, current imaging technology, in particular in inventory environment applications, is quite limiting. Notable among the drawbacks is the lack of diversity among the input images. Typical image capture devices use only monochromatic sensor and capture images from a narrow field of view. These devices are thus only able to capture a relatively limited amount of information on an object. As a result, there is a desire to generate input images that retain considerably more features of an imaged object, so that more comprehensive and more accurate predictive models can be generated using neural networks. There is a particular need to develop predictive models that are based on distinguishing features that are only discernible outside of the visible spectrum. Having more diverse images of an object will also allow object recognition systems to compensate for image variations due to environment and operator differences.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates a perspective view of an example Point-of-Sale station showing a multi-plane imager in the form of a bi-optic barcode scanner, in accordance with an example.

FIG. 2 is a block diagram schematic of a multi-plane imager having multiple sensors and a classification server for training a neural network based on image and sensed data received from the multi-plane imager, in accordance with an example.

FIG. 3 is a diagram of a process flow for training a neural network based on image and sensed data from a multi-plane image, in accordance with an example.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

In accordance with an example, a barcode scanner includes image capture devices and sensors that are collectively able to gather more expansive data on scanned objects. This more expansive data is used, by a neural network, to develop classification models for analyzing subsequent object data. In some examples, the barcode scanner is a multi-plane barcode scanner, such as a bi-optic barcode scanner configured to be supported by a Point-of-Sale station or other workstation.

In some examples, the barcode scanner has a housing with a first housing portion providing a generally horizontal platter having a generally horizontal window and a second housing portion extending away from the first housing portion and providing a generally vertical tower having a generally vertical window. These barcode scanners, which may be bi-optic scanners in some examples, typically include one or more monochrome imagers in its tower and platter. These scanners may include mirror arrangements within its tower and platter to increase the field of view of the imager. The barcode scanner further includes a color imager positioned within the housing and configured to capture a color image of an object through at least one of the generally horizontal window and the generally vertical window. The barcode scanner includes a polychromatic light source configured to illuminate the object with a polychromatic illumination light. In some examples, the polychromatic light source is a white illumination light source. Further still, in some examples, these scanner include illuminators capable of emitting light radiation in non-visible spectrum, such as in the infrared spectrum.

In addition to the color imager, in some examples, the barcode scanner further includes an ambient light sensor, where monochrome imagers, the color imager, and the ambient light sensor generate image data that can be used for generating or updating the classification model.

In some examples, the barcode scanner includes sensors, such as a hyperspectral sensor configured to capture hyperspectral data on the object, where the hyperspectral data includes data from a non-visible spectral range. Other example sensors include distance/depth sensors to measure the distance of an object from the barcode scanner or to measure the depth range of the object.

The barcode scanner includes a controller configured to cause the polychromatic light or non-visible light emitting source to illuminate the object, capture a color image of the object in response to the illumination by polychromatic illumination light, and capture the hyperspectral data using the hyperspectral sensor.

In some examples, a system for developing a classification model for identifying objects includes a barcode scanner, such as a bi-optic scanner, having a first housing portion providing a generally horizontal platter having a generally horizontal window, and a second housing portion extending generally orthogonally from the first housing portion and providing a generally vertical tower having a generally vertical window. The barcode scanner further includes (i) one or more monochromatic imagers, (ii) a color imager configured to capture a color image of an object through at least one of the generally horizontal window and the generally vertical window, (iii) a polychromatic light source configured to illuminate the object with a polychromatic illumination light, (iv) a non-visible light source configured to illuminate the object in non-visible spectrum and (v) a sensor positioned within the housing and configured to capture non-visible, sensed data on the object.

The system additionally includes a classification server configured to receive image data on the object from the barcode scanner and configured to receive non-visible, sensed data for the object from the barcode scanner, the classification server further comprising a neural network framework configured to develop the classification model from the image data and from the non-visible sensed data for identifying objects.

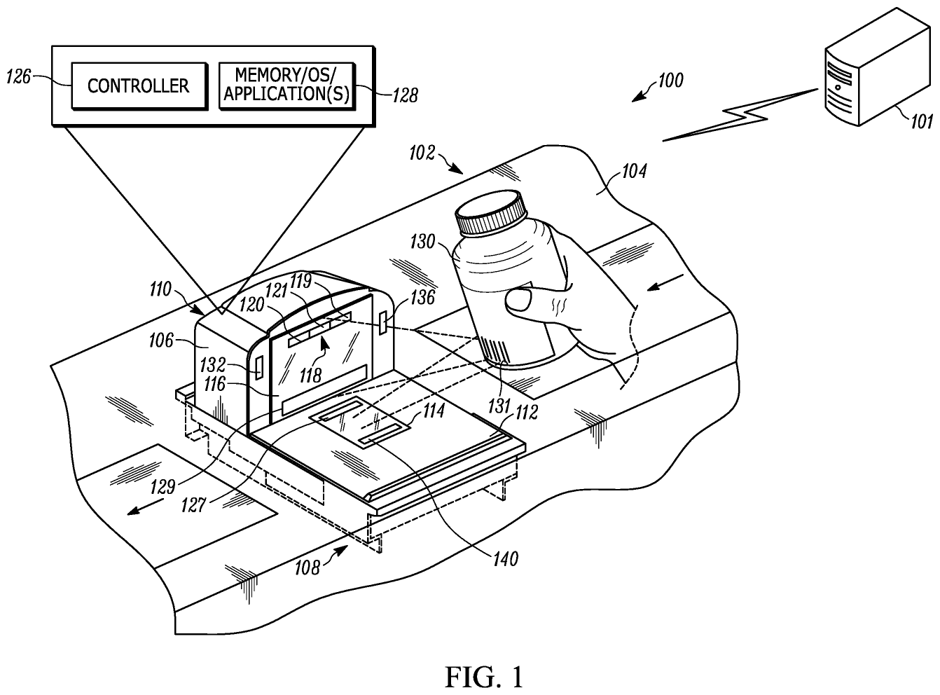

FIG. 1 illustrates a point-of-sale (POS) system 100 for scanning objects as part of a checkout process at a retail environment. The POS system 100 is part of a neural network system in which the POS system 100 is configured to capture image data and other sensed characteristic data on objects scanned at the POS system 100, such as example item 130. The POS 100 communicates the captured image data and sensed data to a classification server 101 having configured to generate classifiers to identifying objects from subsequently captured images and sensed data, using a trained neural network supported on the server 101.

The POS system 100 includes workstation 102 with a countertop 104 and a multi-plane scanner 106 that is communicatively coupled to the classification server 101. In the illustrated example, the multi-plane scanner 106 is a bi-optical (also referred to as “bi-optic”) barcode scanner 106. The bi-optic scanner 106 includes a lower housing (“platter”) 108 and a raised housing (“tower”) 110. The lower housing 108 includes a generally horizontal platter 112 with an optically transmissive window (a generally horizontal window) 114. The horizontal platter 112 may be positioned substantially parallel with the countertop 104 surface. As set forth herein, the phrase “substantially parallel” means+/−10° of parallel and/or accounts for manufacturing tolerances.

The raised housing 110 is configured to extend above the horizontal platter 112. The raised housing 110 includes a second optically transmissive window (a generally vertical window) 116. The vertical window 116 is positioned in a generally upright plane relative to the horizontal platter 112 and/or the first optically transmissive window 114. Note that references to “upright” include, but are not limited to, vertical. Thus, as an example, something that is upright may deviate from a vertical axis/plane by as much as 45 degrees.

The raised housing 110 includes an example illumination assembly 118. The illumination assembly 118 includes an illumination source 119, which is configured to emit a first illumination light at a first, monochromatic wavelength (e.g., at a red wavelength of 640 nm). The illumination assembly 118 may include a second illumination source 120 in the form of a white light illumination source configured to emit over a wide visible spectral region. More generally, the second illumination source 120 may be a polychromic, visible light source configured to simultaneously emit over a plurality of wavelengths in the visible spectrum. The illumination assembly 118 may include another illumination source 121 to emit non-visible light over a wide non-visible spectral region. The monochrome light source 119 may be used for scanning a barcode 131 on an item 130. The white light illumination source 120 may be used to capture images of the item 130, in particular images captured by an imager within one or both of the raised housing 110 an the lower housing 108. In some examples, the white light illumination source 120 is a white light lamp source. In some examples, the white light illumination source 120 is formed of a plurality of other light sources that collectively produce an illumination that spans the visible spectrum, such as a plurality of LEDs each emitting over different wavelength regions (e.g., red, green, and blue). In some examples, the white light illumination source 120 is tunable in response to a controller, to be able to emit an illumination at a particular wavelength within the visible spectrum or a particular combination of wavelengths. That is, the white light illumination source 120 may be configured to emit a monochromatic or poly-chromatic illumination at any tunable wavelength from approximately 390 nm to approximately 700 nm. In some further examples, a third illumination source may be used that emits in a non-visible region, such as in the infrared region.

In contrast to convention bi-optic scanners, the bi-optic scanner 106 is able to generate color images of the object 130, which allows for enhanced visibility of the object, enhanced imaging, and greater information captured in an image of the object, in comparison to monochromatic images. For barcode reading, the monochromatic illumination source 119 is sufficient. However, because the bi-optic scanner 106 is used for classification with the server 101, capturing information on the image at different wavelengths provides for greater information capture and greater diversity of information capture.

The bi-optic scanner 106 includes a controller 126, which may represent one or more processors, and a memory 128, which may represent one or more memories. In operation, the controller 126 causes the illumination assembly 118 to illuminate when the object (item) 130 is swiped past the bi-optic scanner 106. For example, the bi-optic scanner 106 may detect the object 130 in a Field of View extending horizontally from the raised portion 110, in a Field of View extending vertically from the lower housing 108, or a combination of the two. Upon detection, the controller 126 may instruct the illumination source 119 to perform a monochromatic scan to identify a barcode or other indicia on the object 130. An imager 129 within the bi-optic scanner 106 captures the monochromatic image. Upon the detection, the controller may also instruct the illumination source 120 to illuminate the item 130 with a white light illumination or tuned monochromatic or polychromatic illumination. In response, a white light image of the object 130 is captured by the image 129, as well. That is, the imager 129 may be a high resolution color camera, capable of capturing monochromatic images under monochromatic illumination and color images under white light illumination. With color imaging, each pixel in a captured image may have an assigned wavelength, which is not possible with monochromatic images. Further, each captured pixel may store intensity information for that wavelength. Further still, by analyzing sets of pixels over the portions or all of a captured image, the controller 126 can determine a color space and color temperature of the ambient light under which the image was captured, although with a bright enough white light illumination source, the predominant color temperature will be defined mostly by the illumination source and less so by ambient light in the POS 100.

The imager 129 may capture color images through one or both of windows 114 and 116. That is, in some examples, the imager 129 is positioned and angled within the bi-optic scanner 106 to capture images from a horizontally facing FoV from window 116, a vertically facing FoV from window 114, or from a combination of the two FoVs. The color imager may be a one dimensional (1D), two-dimensional (2D), or three-dimensional (3D) color imager, for example. In some examples, the imager 129 represents a plurality of color images within the bi-optic scanner 106, e.g., one in the tower portion and another in a platter portion.

In some examples, the bi-optic scanner 106 may include a dedicated monochrome imager 127 configured to capture monochromatic images (e.g., B/W images) of the object, for example, in response to illumination of the object 130 by the monochromatic illumination source 121.

Multi-dimensional images can be derived by combining orthogonally positioned imagers. For example, 1D color image sensed from a tower portion of the bi-optic scanner and a 1D monochromatic (“B/W”) image sensed from a platter portion of the bi-optic scanner can be combined to form a multi-dimensional image. Other combinations of images may be used as well.

While the white light illumination source 120 is shown in the raised portion 110, in other example, the white light illumination source may be on the lower portion 108. In yet other examples, each portion 108 and 110 may have a white light illumination source.

In addition to capturing colored images of the object 130, the bi-optic scanner 106 may include a hyperspectral sensor 140 that captures image data on the object 130 across a large range of the electromagnetic spectrum. The hyperspectral sensor 140 may capture a spectral range of data for each pixel forming multidimensional data for each pixel The spectral range captured for each pixel may be predetermined from the sensor or may be determined by the controller 126, but either way is typically a contiguous spectral band of wavelengths. For example, the hyperspectral sensor 140 may capture hyperspectral images from 400-1100 nm in steps of 0.1 nm.

In the illustrated example, the hyperspectral sensor 140 is positioned under the window 114 in the platter portion 108, without obstructing the view of the imager 129. This configuration allows the hyperspectral sensor 140 to better capture images of classes of objects like produce that may vary greatly from one imaged object to another. Produce is typically placed on the platter portion 108 during checkout, for example, and the hyperspectral properties of produce can vary greatly depending on properties like freshness, ripeness, or age of the produce, as well as the variety of the produce (e.g., different varieties of applies will generate different hyperspectral images). By capturing hyperspectral image data, the classification server 101 is able to train its neural network to classify objects based on their freshness, ripeness, and/or age.

The controller 126 may be configured to capture hyperspectral images at sensor 140 after capturing monochromatic or color images using the imager 129. For example, the controller 126 may activate the sensor 140 only after the white light illumination source 120 is turned off and not emitting light. In some examples, the controller 126 may activate the sensor 140 to capture one or more images when the illumination source 120 is turned on and emitting light.

In some examples, the bi-optic scanner 106 is a multiple sensor device configured to generate multiple types of data on an object. The bi-optic scanner 106 may include a distance/depth sensor 136 that determines the orthogonal distance of the object 130 from the window 116 of the raised portion 100. The distance may be to a nearest point on the object 130, while in other examples, the distance may be determined from an estimated centroid of the object 130, for example, where the sensor 136 captures a plurality of points and analyzes the points to determine an estimated centroid. Another example of deriving depth is by a Time-Of-Flight process, where time taken for emitted signal to reflect and get sensed by the sensor is used. In some examples, the distance/depth sensor 136 is configured to determine the depth of the object 130, where the depth indicates a farthest identified point for the object 130, as determined from the window 116 of the raised portion. For example, the controller 126 may control the sensor 136 to measure the distance to the object 130, after detecting the presence of the object in a horizontal or vertical FoV of the scanner 106, and before illuminating the object with light from one of the light sources 119, 120. In some examples, the controller 126 may be configured to control an intensity of the illumination light based on the determined distance or depth.

The bi-optic scanner 106 further includes an ambient light sensor 132 which senses the ambient light intensity and color temperature of the ambient light. For example, the controller 126 may control the sensor 132 to determine these sensed ambient light data prior to controlling the illumination light sources 119, 120 to illuminate the object.

While the sensors 132 and 136 are shown on the upper portion 110, one or both of the sensors could be placed on the lower portion 108, or multiple sensor elements could be used for each sensor, whether each portion 110, 108 having a sensor element.

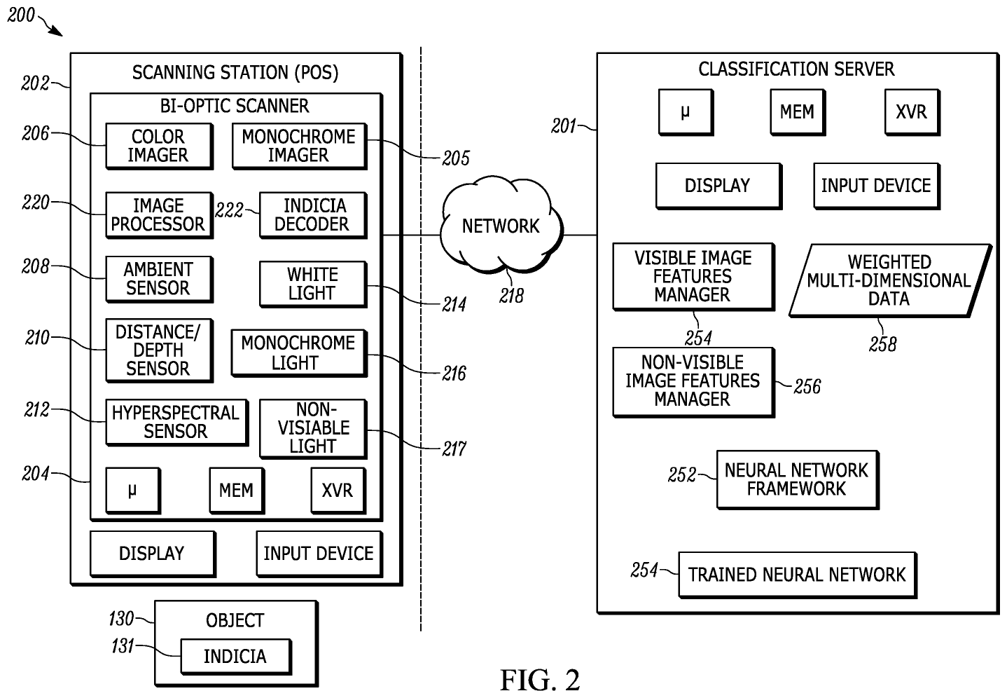

FIG. 2 illustrates a classification system 200 having a scanning station 202, such as a POS scanning station, and classification server 201. The scanning station 202 includes a bi-optic scanner 204, which may implement the bi-optic scanner 106 of FIG. 1. For example, the bi-optic scanner 204 may include one or more monochrome imagers 205, a color imager 206, ambient sensor 208, distance/depth sensor 210, hyperspectral sensor 212, and white light illumination source 214, an optional monochromatic illumination source 216, and an optional non-visible light source 217, each functioning in a similar manner to corresponding elements in the bi-optic scanner 106 and other descriptions herein.

Additionally, the bi-optic scanner 204 includes a controller, which may be one or more processors (“μ”) and one or memories (“MEM”), storing instructions for execution by the one or more processors for performing various operations described herein. The bi-optic scanner 204 includes one or more transceiver (“XVR”) for communicating data to and from the classification server 201 over a wired or wireless network 218, using a communication protocol, such as Ethernet, WiFi etc.

The bi-optic scanner 204 further includes an image processor 220 and an indicia decoder 222. The image processor 220 may be configured to analyze captured images of the object 130 perform preliminary image processing, e.g., before image scan data is sent to the classification server 201. In exemplary embodiments, the image processor 220 identifies the indicia 131 captured in an image, e.g., by performing edge detection and/or pattern recognition, and the indicia decoder 222 decodes the indicia and generates identification data for the indicia 131. The bi-optic scanner 204 sends that identification data along with sensed data and image data to the classification server 201.

Further, while not shown, the bi-optic scanner 204 may include additional sensors, such as an RFID transponder for capturing indicia data is the form of an electromagnetic signal captured from an RFID tag associated with an object.

The scanning station 200 may further include a digital display and a input device, such as a keypad, for receiving input data from a user.

The classification server 201 is configured to execute computer instructions to perform operations associated with the systems and methods as described herein. The classification server 201 may implement enterprise service software that may include, for example, RESTful (representational state transfer) API services, message queuing service, and event services that may be provided by various platforms or specifications, such as the J2EE specification implemented by any one of the Oracle WebLogic Server platform, the JBoss platform, or the IBM WebSphere platform, etc. Other technologies or platforms, such as Ruby on Rails, Microsoft .NET, or similar may also be used.

The classification server 201 includes one or more processors (“μ”) and one or memories (“MEM”), storing instructions for execution by the one or more processors for performing various operations described herein. The server 201 includes a transceiver (“XVR”) for communicating data to and from the bi-optical scanner 204 over the network 218, using a communication protocol, such as WiFi. The classification server 201 may further include a digital display and an input device, such as a keypad.

The classification server 201 includes a neural network framework 250 configured to develop a trained neural network 252 and to use that trained neural network to classify objects based multi-dimensional data, as described herein.

In an example, implementation, the classification server 201 receives a plurality of different visible and non-visible data from the bi-optic scanner 204. The color imager 206 and the ambient sensor 208 generate visible data on the object, in particular a color image of the object and data on the ambient light illuminating the object, respectively. It is noted, that the ambient light data may include data indicating whether the color image was captured when either of the illumination sources 214, 216 were illuminating the object. That is the ambient light data may include illumination data on the ambient light without illumination from any of the light sources on the bi-optic scanner, illumination data (e.g., the wavelength) of the monochromatic illumination, illumination data (e.g., a wavelength range) identifying a white light illumination, or a combination thereof.

A visible features manager 254 receives the visible feature data from the bi-optic scanner 204 and performs initial processing on the data prior to providing the data to a neural network framework 250 for classification training. For example, the manager 154 may determine how many dimensions of visible data is available per pixel of the captured image. Each dimension may represent a different collected data value for the pixel (e.g., color, intensity, ambient light wavelength, ambient light intensity). Each different dimension may be stored as a different data channel for the pixels, for example, where the neural network framework 250 builds classifiers based on the total number of data channels stored for pixels.

The visible image features manager 254 may also identify physical features in the captured color images and store these data on these physical features, e.g., as a labeled image dataset that is used for training the neural network. For example, the manager 254 may determine a peripheral shape of the object, the approximate size of the object, a size of the packaging portion of the object, a size of the product within the packaging (e.g., in the case of a packaged meat or produce), a relative size difference between a size of the product and a size of the packaging, and/or a color of the object, packaging, and shape of product. The physical features may be 1D, 2D, or 3D features of the object, including an estimated 3D volume of the object, 2D surface area of a face of the object, etc.

The visible image features manager 254 may perform additional data analysis, such an processing to enhance visibility of the image across the visible spectrum by reducing image noise in the color image, adjusting the dynamic range of the color image, adjusting the contrast in the color image, etc. The visible image features manager 254 may perform image rotations, image skew adjustments, image alignment, and other geometric-based image processing, as well.

In the example of FIG. 2, the non-visible data may be data from the distance/depth sensor 210 and the hyperspectral sensor 212. A non-visible features manager 256 receives this and any other non-visible feature data from sensors on the bi-optical scanner and generates further multi-dimensional data for each pixel.

In some examples, the non-visible features manager 256 analyzes received hyperspectral image data and adjusts the data based on distance data. The sensitivity of the hyperspectral sensor may dependent on the closer of the sensor to the object, which means that the sensor's sensitivity may change object to object, and even across a single scanned object. The skew of the object at the time of scanning can affect hyperspectral images. By placing the hyperspectral sensor in the platter portion of the bi-optic scanner 204, this variability has been greatly reduced, we have found, meaning that such adjustments by the non-visible features manager 256 are not needed or greatly reduced. Placing the object on the platter for hyperspectral scanning allows for a consistent distance between objet and sensor.

In some examples, the non-visible features manager 256 analyses the hyperspectral data and determines if some portion of the sensed data can be discarded. For example, the non-visible features manager 256 and the visible features manager 254 communicate with one another to enhance their respective analyses. For an object like a piece of fruit/vegetable, the hyperspectral data for the fruit/vegetable will be different than the hyperspectral data for the stem. The visible features manager 254 may be configured to identify and segment out the stem, and the non-visible features manager 256 may receive that segmentation data and then generate hyperspectral data only for the remaining fruit/vegetable portion of the image.

In some examples, the non-visible features manager 256 analyses the hyperspectral data and determines object freshness score, object ripeness score, and/or object age, although such analysis may be performed by the neural network framework 250.

In some examples, the non-visible features manager 256 analyses the hyperspectral data and determines a chemical composition of the object based on the sensed data.

The neural network framework 250 receives the multi-dimensional data from the visible features manager 254 and the non-visible features manager 256, and develops the trained neural network 252. For example, the neural network framework 250 analyzes image data (including physical feature of objects) from the visible features manager 254 and sensed data from the non-visible features manager 256 and determines weights for the data, where these weights provide a relative indication of how strong a correlation exists between the data and identification of an object. Data with higher weights is more likely to correlate to a particular object (and therefore indicate the likely presence of that object or the state of that (ripeness, age, freshness, etc.) in future received image and sensed data.

The neural network framework 250, for example, may be configured as a convolution neural network employing a multiple layer classifier to assess each of the identified physical features and to determine respective weights for each. Weight values for the image data and sensed data may be stored as weighted multi-dimensional data 258. From the determined weighted values, the neural network framework 250 generates and updates the trained neural network 252 for classifying subsequent image and/or sensed data and identifying an object or objects represented by that image and/or sensed data. In some examples, the weighting factors for image data will be sufficiently high to classify objects based on image data along. In some example, the weighting factors for sensed data may be sufficiently high to classify objects based on sensed data. In some examples, certain classifications may be identified from one or image data or sensed data, classifications such as ripeness, freshness, and age identified from sensed data. However, in some examples, the neural network framework 250 generates classifications based on both image data and sensed data. Indeed, in some examples, the trained neural network 252 may determine that age of an object can be classified by a combination of image data, such as size of 3D volume, in combination with sensed data, such as hyperspectral data.

As described herein, the present techniques deploy a trained prediction model to assess received images of an object (with or without indicia) and classifier those images to determine an object. That determination may be used to approve or reject an attempted purchased at a Point-of-Sale for example. In various examples herein, a prediction model is trained using a neural network, and as such that prediction model is referred to herein as a “neural network” or “trained neural network.” The neural network herein may be configured in a variety of ways. In some examples, the neural network may be a deep neural network and/or a convolutional neural network (CNN). In some examples, the neural network may be a distributed and scalable neural network. The neural network may be customized in a variety of manners, including providing a specific top layer such as but not limited to a logistics regression top layer. A convolutional neural network can be considered as a neural network that contains sets of nodes with tied parameters. A deep convolutional neural network can be considered as having a stacked structure with a plurality of layers. In examples herein, the neural network is described as having multiple layers, i.e., multiple stacked layers, however any suitable configuration of neural network may be used.

CNNs, for example, are a machine learning type of predictive model that are particularly using for image recognition and classification. In the exemplary embodiments herein, for example, CNNs can operate on 2D or 3D images, where, for example, such images are represented as a matrix of pixel values within the image scan data. As described, the neural network (e.g., the CNNs) can be used to determine one or more classifications for a given image by passing the image through the series of computational operational layers. By training and utilizing theses various layers, the CNN model can determine a probability that an image or physical image features belongs to a particular class. Trained CNN models can be persisted for restoration and use, and refined by further training. Trained models can reside on any in-premise computer volatile or non-volatile storage mediums such as RAM, flash storage, hard disk or similar storage hosted on cloud servers.

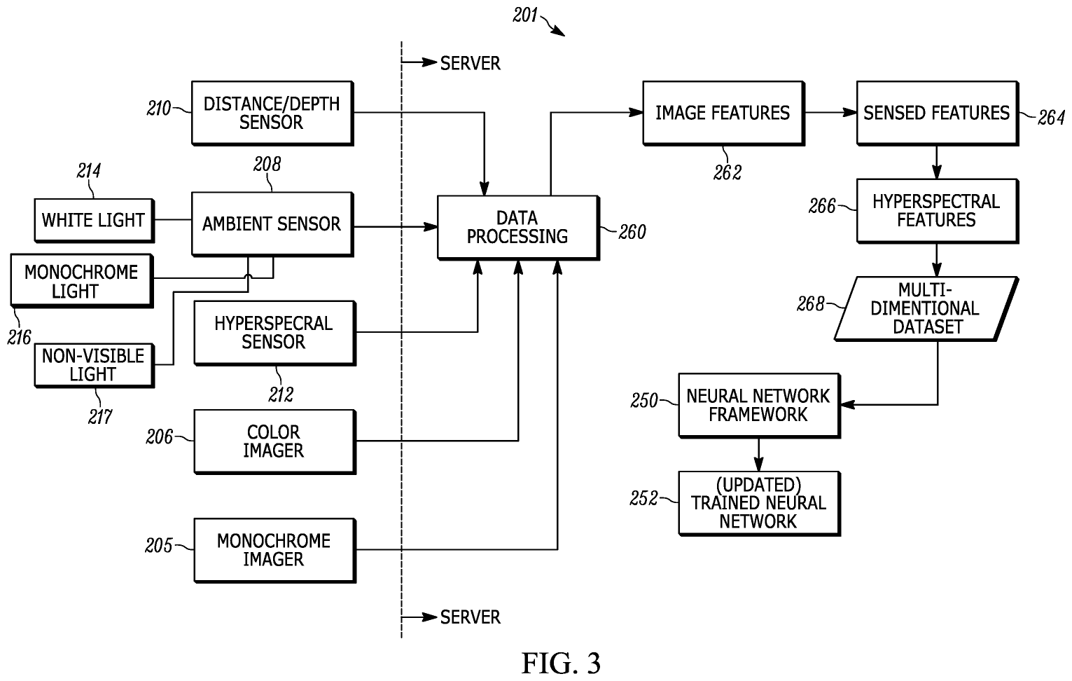

FIG. 3 shows an example process flow where data from the monochrome imager 205, color imager 206, the hyperspectral sensor 212, the ambient sensor 208 (which may include data from the illumination sources 214 and 261), and the distance/depth sensor 210 are provided to the classification server 201, which performs initial data processing 260, for example, to remove noise from each received data stream, to normalize each received data stream, etc. Image data features 262 are identified, for example, from the monochrome imager or color imager and optionally the ambient sensor. Sensed features 264 are identified, for example, from the hyperspectral sensor and the distance/depth sensor. In the illustrated example, additional hyperspectral features 266 are determined from the sensed feature data, where these may include ripeness, freshness, age, or other features derivable from the hyperspectral data. A multi-dimensional dataset 268 is generated from the features, and that dataset is provided to the neural network framework 250 for generating or updating the trained neural network 254.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A barcode scanner configured to be supported by a workstation, the barcode scanner having a housing and comprising:
a first housing portion providing a generally horizontal platter having a generally horizontal window;
a second housing portion extending away from the first housing portion and providing a generally vertical tower having a generally vertical window;
a plurality of imagers positioned within the housing and configured to capture images of an object through at least one of the generally horizontal window and the generally vertical window;
a polychromatic light source configured to illuminate the object with a polychromatic illumination light;
a hyperspectral sensor positioned within the housing and configured to capture hyperspectral data on the object, where the hyperspectral data includes data from a non-visible spectral range; and
a controller configured to cause the polychromatic light source to illuminate the object with the polychromatic illumination light, capture the color image of the object in response to the illumination by polychromatic illumination light, and capture the hyperspectral data using the hyperspectral sensor.

2. The barcode scanner of claim 1, wherein the plurality of imagers comprises a monochrome imager configured to capture one or more monochromatic images of the object.

3. The barcode scanner of claim 1, wherein the plurality of imagers comprises is a color imager configured to capture one or more color images of the object.

4. The barcode scanner of claim 1, wherein the polychromatic light source is positioned within the generally vertical tower of the first housing portion.

5. The barcode scanner of claim 1, wherein the hyperspectral sensor is positioned within the generally horizontal platter of the second housing portion.

6. The barcode scanner of claim 1, wherein the polychromatic light source comprises a white light source.

7. The barcode scanner of claim 6, wherein the white light source is a tunable light source.

8. The barcode scanner of claim 1, wherein the polychromatic light source comprises a white light source and a monochromatic light source.

9. The barcode scanner of claim 1, further comprising an ambient light sensor configured to measure an ambient light intensity, an ambient light color space, and/or an ambient light color temperature.

10. The barcode scanner of claim 1, further comprising a distance sensor configured to determine a distance between the object and one of the first housing portion or the second housing portion.

11. The barcode scanner of claim 1, further comprising a depth sensor configured to determine a depth range of the object.

12. A system for developing a classification model for identifying objects, the system comprising:
a barcode scanner having a first housing portion providing a generally horizontal platter having a generally horizontal window, and a second housing portion extending generally orthogonally from the first housing portion and providing a generally vertical tower having a generally vertical window, the barcode scanner further having (i) a plurality of imagers configured to capture images of an object through at least one of the generally horizontal window and the generally vertical window, (ii) a polychromatic light source configured to illuminate the object with a polychromatic illumination light, and (iii) a sensor positioned within the housing and configured to capture non-visible, sensed data on the object; and
a classification server configured to receive image data on the object from the barcode scanner and configured to receive the non-visible, sensed data for the object from the barcode scanner, the classification server further comprising a neural network framework configured to develop the classification model from the image data and from the non-visible sensed data for identifying objects.

13. The system of claim 12, wherein the sensor is a hyperspectral sensor positioned within the housing and configured to capture hyperspectral data as the non-visible data on the object, where the hyperspectral data includes data from a non-visible spectral range.

14. The system of claim 12, wherein the barcode scanner has an ambient light sensor configured to measure an ambient light intensity, an ambient light color space, and/or an ambient light color temperature.

15. The system of claim 12, wherein the barcode scanner comprises a distance sensor configured to determine a distance between the object and one of the first housing portion or the second housing portion.

16. The system of claim 12, wherein the barcode scanner further comprises a depth sensor configured to determine a depth range of the object.

17. The system of claim 12, wherein the classification server comprises a visible features manager configured to receive image data from the barcode scanner and generate multi-dimensional data on the object, where the classification server is configured to communicate the multi-dimensional data to the neural network framework for use in developing the classification model.

18. The system of claim 12, wherein the classification server comprises a non-visible features manager configured to receive sensed data from the barcode scanner and generate multi-dimensional data on the object, where the classification server is configured to communicate the multi-dimensional data to the neural network framework for use in developing the classification model.

19. The system of claim 12, wherein the plurality of imagers comprises a monochrome imager configured to capture one or more monochromatic images of the object.

20. The system of claim 12, wherein the plurality of imagers comprises is a color imager configured to capture one or more color images of the object.
